(19) United States
(12) Patent Application Publication
(10) Pub. No.: US 2011/0093311 A1
(43) Pub. Date: Apr. 21, 2011

(54) MOBILE TRANSACTION

(75) Inventors: Rajaraman HARIHARAN, Karnataka (IN); Karthik SUBBIAN, Karnataka (IN); Ramakrishnan KANNAN, Karnataka (IN)

(73) Assignee: INTERNATIONAL BUSINESS MACHINES CORPORATION, Armonk, NY (US)

(21) Appl. No.: 12/581,309

(22) Filed: Oct. 19, 2009

(51) Int. Cl. G06Q 30/00; G06Q 10/00

(52) U.S. Cl. 705/7.34; 705/7.29; 705/26.25; 705/27.1

(57) ABSTRACT

Embodiments of the invention are directed to a method, system and computer program product for providing a specific attribute of a particular product. The method may comprise receiving a sequence of characters on a mobile device; determining a list of potential products, each of the list of potential products having a corresponding attribute comprising a matching portion that matches the sequence of characters; determining a location of the mobile device; filtering the list of potential products to a list of relevant products based upon at least one of the location of the mobile device, a consumer defined preference setting, a purchase history of the consumer, and a product ranking but not restricted to the same; ordering the listed products based upon at least one of the above listed criteria's; displaying a list of relevant products on the mobile device; receiving a selection of the particular product from the list of relevant products; and providing the specific attribute of the particular product.

### TECHNICAL FIELD

Embodiment of the invention generally relates to the field of computer technology, and more particularly to a method for providing an attribute of a product as input to a portable electronic device such as a mobile phone.

### BACKGROUND

Large retail stores typically employ information display units to assist consumers obtaining product information such as price, expiration date, and other attributes of a particular product of interest. Installation and management of such information display units create challenges for retailers. Alternatively, portable electronic devices, for example cell phones and/or other mobile devices, operated by consumers or customers may carry certain functionalities of the information display units. For example, consumers may search the inventory of a retail store through a website for any specific product information. A consumer may type the product identifier/code of a particular/specific product in the website to find out more information about the particular product. Product identifiers are typically long strings, and typing such long strings on portable electronic devices such as cell phones may be time consuming due to inherent limitations of cell phones. Such limitations may include, for example, low form factor displays and condensed keypads, for example multiple key presses may be necessary to enter an alphabet.

### SUMMARY

Embodiments of the invention are directed to a method, program and system for providing a specific attribute of a particular product, especially on devices with a low form factor. The method may comprise receiving a sequence of characters on a mobile device, which for example may be representing a portion of a specific attribute of a product; determining a list of potential products based on the sequence of characters, each of the list of potential products having a corresponding attribute comprising a matching portion that matches the sequence of characters; determining a location of the mobile device; filtering the list of potential products to a list of relevant products based upon at least one of the location of the mobile device and a consumer defined preference setting; displaying the list of relevant products on the mobile device; receiving a selection of the particular product from the list of relevant products; and providing the specific attribute of the particular product. Other embodiments are also disclosed.

It is to be understood that both the foregoing general description and the following detailed descriptions are exemplary and explanatory only and are not necessarily restrictive of the embodiments of the invention. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The advantages of the disclosure may be better understood by those skilled in the art by reference to the accompanying figures in which:

FIG. 1 is an exemplary embodiment of a flow diagram illustrating a method for providing an attribute of a product as input to a mobile device;

FIG. 2 is an exemplary embodiment of a data processing system on which the method of FIG. 1 may be implemented.

### DETAILED DESCRIPTION

Reference will now be made in detail to the subject matter disclosed, which is illustrated in the accompanying drawings.

Embodiments of the invention are directed to a method, system and program for providing an attribute of a product as input to a mobile device. The method provides an auto-completion feature based on the location of the mobile device. For example, upon receiving a partially entered product identifier, the method may determine a list of potential products with identifiers starting with the partially entered product identifier. The method may filter the list of potential products based on the location of the mobile device. For example, if the mobile device is located in an electronic store, the filtered list of products may only contain electronic products as relevant products.

The method may further prioritize the relevant products based on additional criteria, such as purchase history of the consumer, product ranking, etc. The relevant products may be displayed on the mobile device in order for the consumer to select the intended product. Once the consumer selects the intended product from the relevant list, the method auto-completes the remaining portion of the partially entered product identifier based on the identifier of the intended product selected.

It is contemplated that the display of relevant products for the consumer to select may vary. In one embodiment, a selection list comprising product identifiers of the relevant products is displayed. In another embodiment, the selection list may comprise product names. In still another embodiment, the selection list may comprise product descriptions and/or product images. It is understood that the selection list may comprise various product properties/attributes and/or combinations of such properties to assist consumers in identifying the intended product.

It is contemplated that the location of the mobile device may be determined utilizing various methods, including, but not limited to, GPS and/or cellular triangulation. Once the location of the mobile device is determined, a map may be referenced to determine the type of store (e.g., electronics, clothing, etc.) the mobile device is located in.

It is also contemplated that the location of the mobile device within a store may be determined. This may be beneficial in large retail stores having different sections/departments. For example, if the mobile device is located in a retail store having a grocery section, an electronics section and a clothing section, knowing the mobile device is located in the clothing section may help further filter the list of potential products.

Various techniques may be employed in determining the location of a mobile device within a store, and these should be obvious to one skilled the art. In one embodiment, the location of the mobile device is calculated by a server in the store utilizing WiFi triangulation. The server may determine the signal strength from the mobile device to at least three of its wireless access points. Based on these three values, the location of the device may be calculated utilizing triangulation. In another embodiment, detection techniques may be employed to detect mobile devices with embedded RFID chips.

It is further contemplated that the method may evaluate changes to the location of the mobile device. The list of relevant products may be determined dynamically based on the location changes. For example, if the consumer moves from the electronics section to the clothing section, the list of relevant products may be modified to include clothing products instead of electronic products. Additionally, a predetermined threshold may be utilized to discard temporary location changes. For example, the new location may be evaluated to determine the list of relevant products only if the mobile device stays in the new location for at least two minutes.

It is still further contemplated that other product attributes may be utilized for product lookup. For example, a partially entered model number of a product may be utilized instead of the product identifier. In addition, non-identifying product attributes that do not uniquely identify a product (e.g., price, color, or size), may also be utilized. For example, entering a particular price may trigger the method to generate a list of relevant products that are sold at the particular price at the same location as the mobile device. It is understood that any attribute of a product, or a combination of multiple attributes of the product, may be utilized by the method to generate a List of potential products, which may be filtered down to a list of relevant products based on the location of the mobile device.

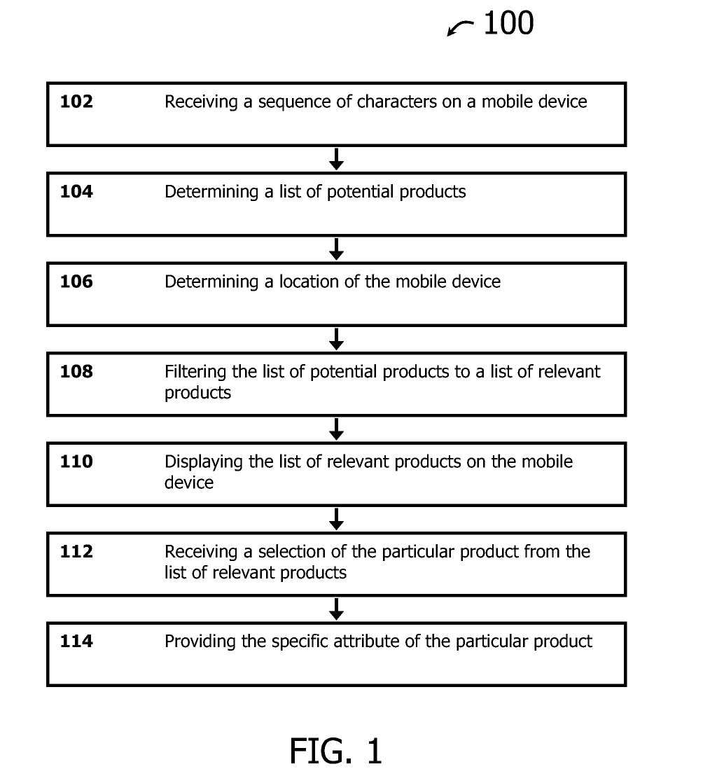

FIG. 1 is an exemplary embodiment of a flow diagram illustrating steps performed by a method 100 in accordance with the embodiments of the present invention. The method may be utilized for providing a specific attribute of a particular product as an input to a mobile device. Step 102 receives a sequence of characters. For example, the sequence of characters may represent a portion of an attribute that uniquely identifies the product. For instance, this could be a first few characters of the product code.

The attribute which the sequence of characters represents may or may not be the same as the specific attribute. For instance, a consumer (also known as a customer or user) may try to provide the model number of the product as the specific attribute to the mobile device by entering a first few characters of the model number. In another instance, the consumer may provide a first few characters of the product code, instead of providing the model number, for example, when the model number is too complex. In this instance, the later steps of the method may utilize the product code to identify the product, and provide the corresponding the model number to the mobile device.

In another example, the sequence of characters received in step 102 may represent a portion of an attribute that does not uniquely identify the product. For example, this includes a non-identifying attribute such as price, color, or size. The non-identifying attribute may be utilized by the method in conjunction with location of the mobile device to identify the desired product, and provide the corresponding specific attribute of the product to the mobile device.

Step 104 determines a list of potential products, wherein each potential product has a corresponding attribute comprising a matching portion that matches the sequence of characters. For example, the list of potential products may comprise all products with product codes starting with the same sequence of characters entered in step 102. In another example, if a non-identifying attribute (e.g., price attribute of $9.99) is entered in step 102, the list of potential products may comprise all products available in the store that are priced at $9.99.

The location of the mobile device is determined in step 106. Step 108 filters the list of potential products down to a list of relevant products based upon the location of the mobile device and/or a consumer defined preference setting. The consumer defined preference setting may be a selection/filtering criteria defined by the consumer. For example, if a consumer is a vegetarian, the consumer may define the preference setting to exclude meat products.

In another example, if a non-identifying attribute (e.g., price attribute of $9.99) is entered in step 102, the list of potential products may comprise all products available in the store that are priced at $9.99. Step 108 may therefore filter the list of potential products based on the location of the mobile device to a smaller, more relevant list of products.

Step 110 displays the list of relevant products on the mobile device. For example, if the consumer is attempting to enter the product code of a particular product to a form displayed on the mobile device, an auto-fill list comprising product codes of all relevant products may be generated for the consumer to select from.

Alternatively, different attributes may be provided for the consumer to select. For instance, if the model numbers of the relevant products are shorter compared to the product codes (hence relatively easier for the consumer to identify), the auto-fill list may be generated and comprise a list of model numbers. Subsequently, upon selection, the corresponding product code of the selected product may be entered into the mobile device. In another instance, images of the relevant products may be utilized to help better identify the desired product. In still another example, combinations of attributes may be displayed. It is understood that additional attributes may be displayed, and that the attribute/attributes displayed for the list of relevant products may or may not be the same attribute as that is provided in step 102.

Step 112 receives a selection of the particular product from the list of relevant products. Step 114 fills in the specific attribute of the particular product, and effectively auto-completes the partially entered sequence of characters.

Embodiment of the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

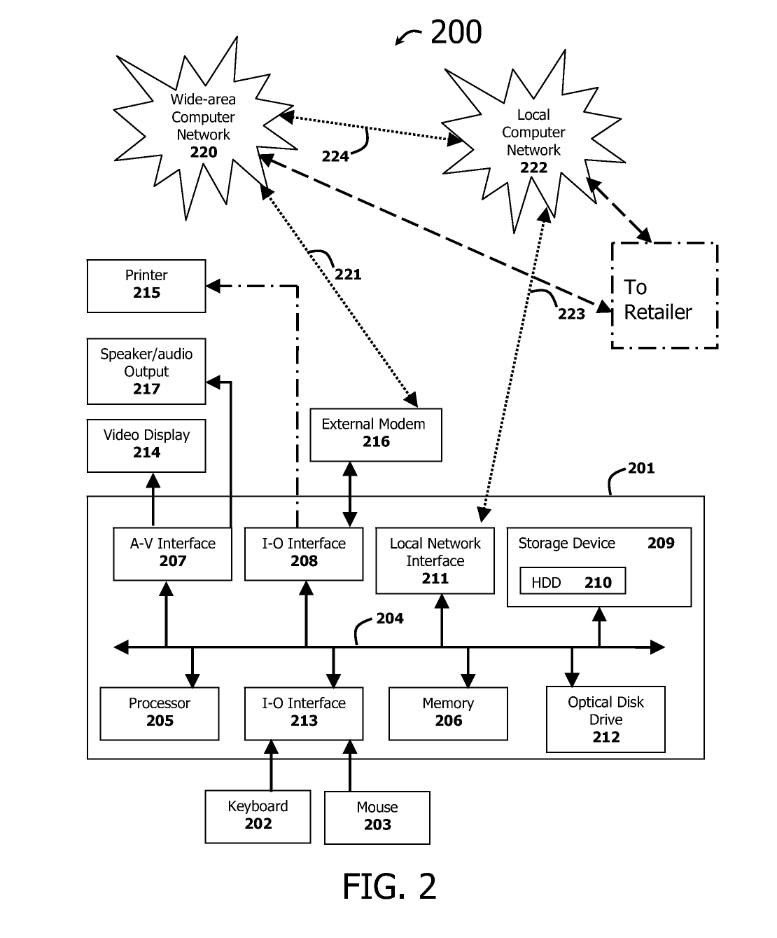

Method 100 may be implemented using a data processing system 200 (also referred to as a computing system or computer system), such as that shown in FIG. 2 wherein the processes of FIG. 1 may be implemented as software, such as one or more application programs executable within the computer system 200. The data processing system includes devices such as a mobile phone, a PDA and the likes. In particular, the steps of method 100 are effected by instructions in the software that are carried out within the data processing system 200. The instructions may be formed as one or more code modules, each for performing one or more particular tasks. The software may be stored in a computer readable medium, including the storage devices described below, for example.

The software is loaded into the data processing system 200 from the computer readable medium, and then executed by the computer system 200. A computer readable medium having such software or computer program recorded on it is a computer program product. The use of the computer program product in the computer system 200 preferably effects an advantageous apparatus for performing transaction as disclosed in method 100 of FIG. 1.

As seen in FIG. 2, the computer system 200 is formed by a computer module 201, input devices such as a keyboard 202 and a mouse pointer device 203, and output devices including a printer 215, a display device 214 and loudspeakers 217. An external Modulator-Demodulator (Modem) transceiver device 216 may be used by the computer module 201 for communicating to and from a communications network 220 via a connection 221. The network 220 may be a wide-area network (WAN), such as the Internet or a private WAN. Where the connection 221 is a telephone line, the modem 216 may be a traditional “dial-up” modem. Alternatively, where the connection 221 is a high capacity (eg: cable) connection, the modem 216 may be a broadband modem. A wireless modem may also be used for wireless connection to the network 220.

The computer module 201 typically includes at least one processor unit 205, and a memory unit 206 for example formed from semiconductor random access memory (RAM) and read only memory (ROM). The module 201 also includes an number of input/output (I/O) interfaces including an audio-video interface 207 that couples to the video display 214 and loudspeakers 217, an I/O interface 213 for the keyboard 202 and mouse 203 and optionally a joystick (not illustrated), and an interface 208 for the external modem 216 and printer 215.

In some implementations, the modem 216 may be incorporated within the computer module 201, for example within the interface 208. The computer module 201 also has a local network interface 211 which, via a connection 223, permits coupling of the computer system 200 to a local computer network 222, known as a Local Area Network (LAN). As also illustrated, the local network 222 may also couple to the wide network 220 via a connection 224, which would typically include a so-called “firewall” device or similar functionality. The interface 211 may be formed by an Ethernet™ circuit card, a wireless Bluetooth™ or an IEEE 802.11 wireless arrangement.

The interfaces 208 and 213 may afford both serial and parallel connectivity, the former typically being implemented according to the Universal Serial Bus (USB) standards and having corresponding USB connectors (not illustrated). Storage devices 209 are provided and typically include a hard disk drive (HDD) 210. Other devices such as a floppy disk drive and a magnetic tape drive (not illustrated) may also be used. An optical disk drive 212 is typically provided to act as a non-volatile source of data. Portable memory devices, such optical disks (eg: CD-ROM, DVD), USB-RAM, and floppy disks for example may then be used as appropriate sources of data to the system 200.

The components 205, to 213 of the computer module 201 typically communicate via an interconnected bus 204 and in a manner which results in a conventional mode of operation of the computer system 200 known to those in the relevant art. Examples of computers on which the described arrangements can be practiced include desktop computers, laptop computers, pocket personal computers, portable electronic devices such as PDA's, mobile phones and the likes.

Typically, the application programs discussed above are resident on the hard disk drive 210 and read and controlled in execution by the processor 205. Intermediate storage of such programs and any data fetched from the networks 220 and 222 may be accomplished using the semiconductor memory 206, possibly in concert with the hard disk drive 210. In some instances, the application programs may be supplied to the user encoded on one or more CD-ROM and read via the corresponding drive 212, or alternatively may be read by the user from the networks 220 or 222. Still further, the software can also be loaded into the computer system 200 from other computer readable media.

Computer readable media refers to any storage medium that participates in providing instructions and/or data to the computer system 200 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 201. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like. Accordingly, such computer programs represent controllers of the data processing system.

Embodiments of the invention disclose methods that may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

When a single element or article is described herein, it will be apparent that more than one element/article (whether or not they cooperate) may be used in place of a single element/article. Similarly, where more than one element or article is described herein (whether or not they cooperate), it will be apparent that a single element/article may be used in place of the more than one element or article. The functionality and/or the features of an element may be alternatively embodied by one or more other elements which are not explicitly described as having such functionality/features. Thus, other embodiments need not include the element itself.

Although embodiments of the invention have been described with reference to the embodiments described above, it will be evident that other embodiments may be alternatively used to achieve the same object. The scope is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. Embodiments of the invention can be implemented by means of hardware comprising several distinct elements

Embodiment of the invention and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing a specific attribute of a particular product, the method comprising:
determining a current location of a device;
displaying a list of relevant products on the device, wherein each of the relevant products has an associated specific attribute.

2. The method as claimed in claim 1, further comprising:
receiving a sequence of characters as input on the device.

3. The method as claimed in claim 2, further comprising:
determining a list of potential products, wherein each of the list of potential products have a corresponding attribute comprising a matching portion that matches the received sequence of characters.

4. The method as claimed in claim 3, further comprising:
filtering the list of potential products to determine the list of relevant products based upon at least one of the current location of the device, a consumer defined preference setting, a purchase history of the consumer, and a product ranking.

5. The method as claimed in claim 4, further comprising:
ordering the filtered list of potential products based upon at least one of the current location of the device, the consumer defined preference setting, the purchase history of the customer, and the product ranking.

6. The method as claimed in claim 4, further comprising:
receiving a selection of the particular product from the list of relevant products;
providing the specific attribute of the particular product; and
displaying the list of potential products using at least one of a product property, a product attribute, and a combination of such property and product attribute, wherein the product property and product attribute comprise at least one of a product name, a product code, a product image, and a product description.

7. The method as claimed in claim 1, wherein the device includes a portable electronic device.

8. The method as claimed in claim 6, wherein the portable electronic device comprises at least one of a mobile phone, a personal digital assistant, a laptop computer, and a pocket personal computer.

9. A system comprising at least a processor and a memory, the system configured for providing a specific attribute of a particular product by:
determining a current location of a device; and
displaying a list of relevant products on the device, wherein each of the relevant products has an associated specific attribute.

10. The system as claimed in claim 9, further configured for:
receiving a sequence of characters as input on the device.

11. The system as claimed in claim 10, further configured for:
determining a list of potential products, wherein each of the list of potential products have a corresponding attribute comprising a matching portion that matches the received sequence of characters.

12. The system as claimed in claim 11, further configured for:
filtering the list of potential products to determine the list of relevant products based upon at least one of the current location of the device, a consumer defined preference setting, a purchase history of the consumer, and a product ranking.

13. The system as claimed in claim 12, further configured for:
ordering the filtered list of potential products based upon at least one of the current location of the device, the consumer defined preference setting, the purchase history of the customer, and the product ranking.

14. The system as claimed in claim 12, further configured for:
receiving a selection of the particular product from the list of relevant products;
providing the specific attribute of the particular product;
displaying the list of potential products using at least one of a product property, a product attribute, a combination of such property and product attribute, wherein the product property and the product attribute comprise at least one of a product name, a product code, a product image, and a product description.

15. The system as claimed in claim 9, wherein the device includes a portable electronic device, wherein the portable electronic device comprises at least one of a mobile phone, a personal digital assistant, a laptop computer, and a pocket personal computer.

16. A computer program product comprising a computer usable medium having computer usable program code embodied therewith, the computer usable program code configured for:
determining a current location of a device; and
displaying a list of relevant products on the device, wherein each of the relevant products has an associated specific attribute.

17. The product as claimed in claim 16, further comprising computer usable code configured for:
receiving a sequence of characters as input on the device.

18. The product as claimed in claim 17, further comprising computer usable code configured for:
determining a list of potential products, wherein each of the list of potential products have a corresponding attribute comprising a matching portion that matches the received sequence of characters.

19. The product as claimed in claim 18, further comprising computer usable code configured for:
filtering the list of potential products to determine the list of relevant products based upon at least one of the current location of the device, a consumer defined preference setting, a purchase history of the consumer, and a product ranking.

20. The product as claimed in claim 19, further comprising computer usable code configured for:
ordering the filtered list of potential products based upon at least one of the current location of the device, the consumer defined preference setting, the purchase history of the customer, and the product ranking;
receiving a selection of the particular product from the list of relevant products;
providing the specific attribute of the particular product; and
displaying the list of potential products using at least one of a product property, a product attribute, a combination of such property and product attribute, wherein the product property and the product attribute comprise at least one of a product name, a product code, a product image, and a product description.
